(19) United States
(12) Patent Application Publication
(10) Pub. No.: US 2026/0062231 A1
(43) Pub. Date: Mar. 5, 2026

(54) PARTS FEEDING SYSTEM

(71) Applicant: NTN CORPORATION, OSAKA (JP)

(72) Inventors: Seigo SAKATA, Iwata (JP); Toru MIYAKE, Iwata (JP); Yukihiro KURITA, Iwata (JP); Naoki MARUI, Iwata (JP)

(73) Assignee: NTN CORPORATION, OSAKA (JP)

(21) Appl. No.: 19/316,753

(22) Filed: Sep. 2, 2025

(30) Foreign Application Priority Data
Sep. 4, 2024 (JP) 2024-152153
Sep. 4, 2024 (JP) 2024-152154

(51) Int. Cl. B65G 47/14

(52) U.S. Cl. CPC B65G 47/1478; B65G 47/1421

(57) ABSTRACT

A parts feeding system includes: a conveyance carrier having an arc shape including a circular shape or an elliptic arc shape including an elliptic shape for conveying a workpiece; a parts feeder feeding the workpiece to the conveyance carrier; and a robot fixed at a base end thereof and picking up the workpiece on the conveyance carrier at a tip end thereof. The robot has a plurality of arm members rotating around rotational axes, and a first rotational axis at the most basal end side is located inside a virtual circle or a virtual ellipse of the conveyance carrier.

### CROSS REFERENCE TO THE RELATED APPLICATION

This application is based on and claims Convention priority to a Japanese patent application No. 2024-152153 and a Japanese patent application No. 2024-152154 filed Sep. 4, 2024, the entire disclosures all of which are herein incorporated by reference as a part of this application.

### BACKGROUND OF THE INVENTION

### Field of the Invention

The present invention relates to a parts feeding system including a parts feeder that feeds workpieces such as mechanical components, electronic components, or other components to a conveyance carrier and a robot that picks up the workpieces on the conveyance carrier and feeds them to the next process.

### Description of Related Art

A parts feeding system has been known in which workpieces such as mechanical components, electronic components, or other components are automatically aligned, fed to a conveyance carrier, picked up on the conveyance carrier by a robot and fed to the next process (for example, JP Patent No. 6892952, JP Laid-open Patent Publication No. 2024-002216, and JP Laid-open Patent Publication No. 2024-002217). In the parts feeding system of JP Patent No. 6892952, JP Laid-open Patent Publication No. 2024-002216, and JP Laid-open Patent Publication No. 2024-002217, since the parts feeding system includes a parts feeder having a disk-shaped conveyance carrier, it is possible to achieve saving space compared to a liner conveyance carrier.

However, in the parts feeding system of JP Patent No. 6892952, JP Laid-open Patent Publication No. 2024-002216, and JP Laid-open Patent Publication No. 2024-002217, the robot is installed outside the disk-shaped conveyance carrier, which takes a large space for the system as a whole.

### SUMMARY OF THE INVENTION

An object of the present invention is to provide a parts feeding system which can achieve saving space as a whole system.

A parts feeding system according to a first configuration of the present invention includes: a conveyance carrier having an arc shape including a circular shape or an elliptic arc shape including an elliptic shape for conveying a workpiece; a parts feeder feeding the workpiece to the conveyance carrier; and a robot fixed at a base end thereof and picking up the workpiece on the conveyance carrier at a tip end thereof. The robot has an arm member rotating around a rotational axis, and the rotational axis at the most basal end side is located inside a virtual circle or a virtual ellipse of the conveyance carrier. The conveyance carrier is in a circular shape, an arc shape, an elliptic shape or an elliptic arc shape.

According to this configuration, since the robot is located on an inner diameter side of the conveyance carrier having an arc shape including a circular shape or an elliptic arc shape including an elliptic shape, an occupied area of the parts feeding system can be reduced. As a result, it is possible to achieve saving space of the whole system.

In the first configuration of the present invention, the robot may be located so that the rotational axis at the most basal end side is located at a center portion of the conveyance carrier. In this case, the robot may be located so that the rotational axis of the arm mechanism corresponds to the center of the virtual circle or virtual ellipse of the conveyance carrier.

In the first configuration of the present invention, the robot may have a plurality of the arm members. When there is one arm member, the rotational axis at the most basal end side is the rotational axis of one arm member.

In the first configuration of the present invention, the parts feeder includes: a vibrating bowl feeder having a bowl that conveys and feeds the stored workpiece along a conveying path while aligning the stored workpiece by vibration; and a conveyance carrier that conveys the aligned workpiece fed from the vibrating bowl feeder, wherein the conveyance carrier may be arranged in an annular shape along an outer periphery of the vibrating bowl feeder and may have a rotating disk having an upper surface which forms a conveyance surface of the workpiece. According to this configuration, since the parts feeder includes a disk-shaped conveyance carrier and the workpieces is fed from its inside, it is possible to achieve saving space of the whole system.

A parts feeding system according to a second configuration of the present invention includes: a conveyance carrier having a rotating disk shape for conveying a workpiece; a robot fixed at a base end thereof and picking up the workpiece moving on the conveyance carrier at a tip end thereof; a workpiece detector that detects a position of the workpiece on the conveyance carrier; a rotation sensor that detects a phase position of the rotating disk; and a controller that controls the robot based on the detected values by the workpiece detector and the rotation sensor. The robot has an arm member rotating around a rotational axis, and is located so that the rotational axis at the most basal end side is located at a center portion of the conveyance carrier. The robot is configured to be able to follow the movement of the workpiece by rotating around the rotational axis at the most basal end side.

For example, the robot may be located so that the rotational axis at the most basal end side corresponds to a rotational axial center of the conveyance carrier. In this case, the robot may have a plurality of the arm members.

For example, in a parts feeding system described in JP Patent No. 2652789, complex coordinate calculations such as circular interpolation are required to make a robot follow a workpiece moving on a rotating disk.

According to the above configuration, the rotational axis of the robot at the most basal end side is located at the center of the conveyance carrier having the rotating disk shape. As a more favorable embodiment, the rotational axis of the robot at the most basal end side corresponds to the rotational axial center of the conveyance carrier having the rotating disk shape. This allows them to rotate synchronously without complex coordinate calculations such as circular interpolation. Accordingly, it is possible to enable the robot to follow the workpiece moving on the rotating disk at the tip end portion beyond the rotational axis at the most basal end side. In this way, since complex coordinate calculations are not required, it is possible to simplify programming of the controller and to shorten a control period (tact time). In addition, since the following is performed only by rotation around the rotational axis at the most basal end side, there is no interference between the arms moving, which improves positioning accuracy.

In the second configuration of the present invention, the controller may include: an estimate processor that calculates a timing when the workpiece reaches a picking process starting position based on the detected values by the workpiece detector and the rotation sensor; a movement processor that moves a workpiece gripping portion of the arm located at the tip end of the robot to a position just above the picking process starting position before or simultaneously with the timing when the workpiece reaches the picking process starting position calculated by the estimate processor; and a follow-up processor that makes the workpiece gripping portion follow the movement of the workpiece to pick up the workpiece by rotating the robot around the rotational axis at the most basal end side at the timing when the workpiece reaches the picking process starting position.

Instead, the controller may include: an estimate processor that calculates a timing when the workpiece reaches the picking process starting position and a standby position on a workpiece track on the upstream side of the picking process starting position based on the detected values by the workpiece detector and the rotation sensor; a movement processor that moves a workpiece gripping portion of the arm located at the tip end of the robot to the standby position before or simultaneously with the timing when the workpiece reaches the standby position calculated by the estimate processor; and a follow-up processor that makes the workpiece gripping portion follow the movement of the workpiece to pick up the workpiece on the downstream side of the picking process starting position by rotating the robot around the rotational axis at the most basal end side at the timing when the workpiece reaches the position just below the workpiece gripping portion.

In both controllers, the robot can follow the workpiece moving on the rotating disk without complex coordinate calculations such as circular interpolation.

In the second configuration of the present application, the system may include a parts feeder feeding the workpiece to the conveyance carrier, in which the parts feeder may include: a vibrating bowl feeder having a bowl that conveys and feeds the stored workpiece along a conveying path while aligning the stored workpiece by vibration; and a conveyance carrier that conveys the aligned workpieces fed from the vibrating bowl feeder, wherein the conveyance carrier may be arranged in an annular shape along an outer periphery of the vibrating bowl feeder and may have a rotating disk having an upper surface which forms a conveyance surface of the workpiece. According to this configuration, since the parts feeder includes a disk-shaped conveyance carrier in which the robot is located and the workpieces is fed from its inside, it is possible to achieve saving space of the whole system.

The present invention encompasses any combination of at least two features disclosed in the claims and/or the specification and/or the drawings. In particular, any combination of two or more of the appended claims should be equally construed as included within the scope of the present invention.

### BRIEF DESCRIPTION OF THE DRAWINGS

The present disclosure will be more clearly understood from the following description of preferred embodiments made with reference to the accompanying drawings. However, the embodiments and the drawings are given merely for the purpose of illustration and explanation, and should not be used to delimit the scope of the present disclosure, which scope is to be delimited by the appended claims. In the accompanying drawings, alike numerals are assigned to and indicate alike or corresponding parts throughout the different figures, and:

FIG. 1 is a top plan view of a parts feeding system according to a first embodiment of the present invention;

FIG. 2 is a side view of the parts feeding system;

FIG. 3 is a perspective view illustrating a relevant part of the parts feeding system;

FIG. 4 is a top plan view of a variation of the parts feeding system;

FIG. 5 is a top plan view of a parts feeding system according to a second embodiment of the present invention;

FIG. 6 s a side view of the parts feeding system;

FIG. 7 is a top plan view of a variation of the parts feeding system;

FIG. 8 a top plan view of a parts feeding system according to a third embodiment of the present invention;

FIG. 9A is a top plan view illustrating the operation of the parts feeding system;

FIG. 9B is a top plan view illustrating the operation of the parts feeding system;

FIG. 9C is a top plan view illustrating the operation of the parts feeding system; and

FIG. 9D is a top plan view illustrating the operation of the parts feeding system.

### DESCRIPTION OF EMBODIMENTS

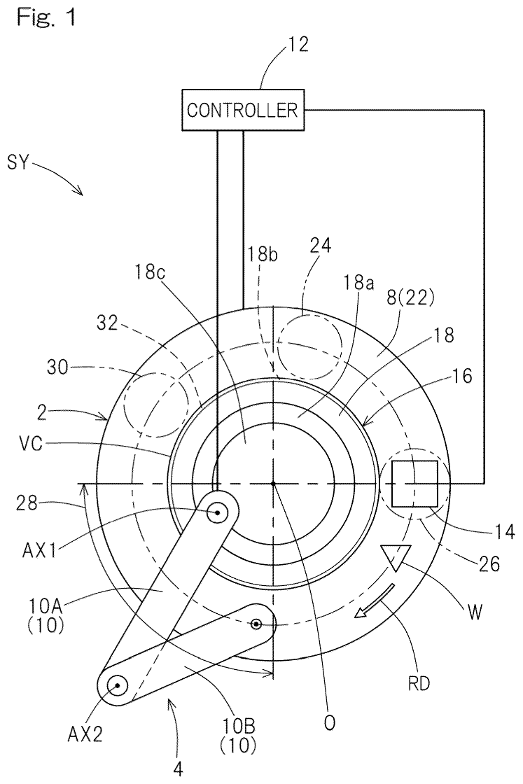

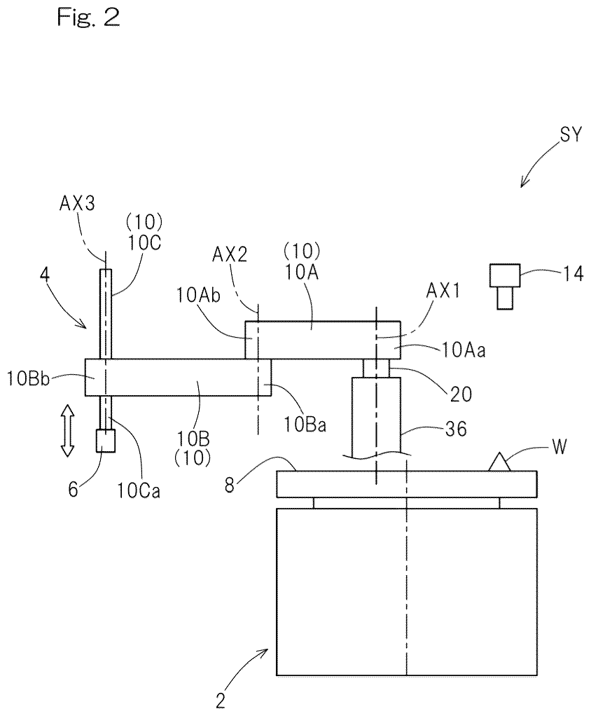

Favorable embodiments of the present invention will be described in lights of Figures. FIG. 1 is a top plan view of a parts feeding system SY according to a first embodiment of the present invention, and FIG. 2 is a side view thereof. In the following description, the “upper stream” and the “down stream” refer to the “upper stream” and the “down stream” in a flow direction of a workpiece.

### Whole System

As shown in FIG. 1, a parts feeding system SY picks up a workpiece W, that is automatically aligned by a parts feeder 2, with a robot 4 and a hand 6 (FIG. 2) and feeds it to an automatic machine for the next process. In detail, the parts feeding system SY includes: the parts feeder 2 that feeds the workpiece W to a conveyance carrier 8; the robot 4 that conveys the workpiece W on the conveyance carrier 8; and the hand 6 (FIG. 2) attached to a tip of an arm mechanism 10 of the robot 4. The workpiece W is, for example, machine parts, electronic parts, plastic parts, medicines, medical supplies, foods, or miscellaneous goods.

A controller 12 synchronously controls the parts feeder 2, the robot 4 and the hand 6. Specifically, a workpiece detector 14 detects the position and posture of the workpiece W on the conveyance carrier 8, the arm mechanism 10 of the robot 4 moves to the position detected by the workpiece detector 14, and the hand 6 in FIG. 2 grips the workpiece W at an angle corresponding to the posture detected by the workpiece detector 14. Then, the arm mechanism 10 of the robot 4 moves to the position where the workpiece is placed (hereinafter referred to as “place position”), and the hand 6 releases the workpiece W. Thereafter, this operation is repeated.

In this embodiment, the workpiece detector 14 is a photographing means such as a camera. However, the workpiece detector 14 is not limited to a camera, but may be, for example, a distance sensor or a contact-type one. The camera may be provided only for detecting the position and posture of the workpiece W or may be used for other purposes as well. Further, the camera may be fixed and attached to the arm 10 of the robot 4.

### Parts Feeder

The parts feeder 2 includes: a vibrating bowl feeder 16 aligning the stored workpiece W by vibration; and the conveyance carrier 8 that conveys the aligned workpiece W fed from the vibrating bowl feeder 16. The conveyance carrier 8 of this embodiment is arranged so as to surround an outer periphery of the vibrating bowl feeder 16 along the outer periphery of the vibrating bowl feeder 16.

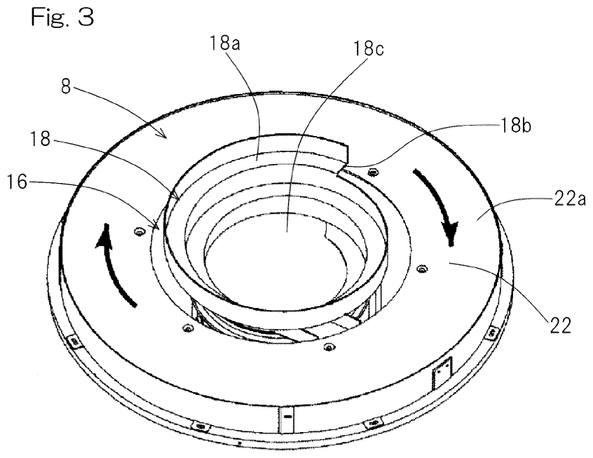

The vibrating bowl feeder 16 includes: a bowl 18 having a conveying path 18a on its inner peripheral surface; and a vibrator (not illustrated) that vibrates the bowl 18. As shown in FIG. 3, the workpiece W stored in the bowl 18 is aligned by vibration of the vibrator and sequentially conveyed along the conveying path 18a to a workpiece discharging section 18b located at the uppermost position of the conveying path 18a.

The bowl 18 includes: a bottom 18c for storing the workpiece W; and the conveying 18a that spirals upward from an outer diameter side of the bottom 18c. The workpiece discharging section 18b is formed at the uppermost position of the conveying path 18a.

The workpiece put into the bottom 18a of the bowl 18 is aligned and sequentially fed out from the lower side to the upper side of the conveying path 18a on the inner peripheral surface by vibration of the bowl 18. Then, the workpiece W is ejected from the workpiece discharging section 18b located at the uppermost position of the conveying path 18a.

The conveyance carrier 8 of this embodiment is arranged in an annular shape along the outer periphery of the vibrating bowl feeder 16. The conveyance carrier 8 has a rotating disk 22 having an upper surface which forms an annular-shaped conveyance surface 22a of the workpiece W. The conveyance surface 22a and the workpiece discharging section 18b are adjusted at the approximately same height. The rotating disk 22 is turned and driven by a rotary driving device (not illustrated) and rotates around a rotational center O in a rotational direction RD. The rotary driving device is, for example, an electric motor, but is not limited to this. In addition, since an encoder (not illustrated) is connected to a drive shaft of a drive motor, it is possible to detect the phase position of the rotating disk 22.

On the conveyance surface 22a of the upper surface of the rotating disk 22, a workpiece feeding area 24, a sensing area 26, a pickup area 28, and a workpiece recovering area 30 are provided, aligned in a circumferential direction. The workpiece feeding area 24 is an area where the workpiece W is fed from the workpiece discharging section 18b.

The sensing area 26 is located at the down stream side of the workpiece feeding area 24 in the flow direction of the workpiece. At the sensing area 26, the position and posture of the workpiece W are detected by the workpiece detector 14.

The pickup area 28 is located at the down stream side of the sensing area 26 in the flow direction of the workpiece. At the pickup area 28, the robot 4 and the hand 6 pick up the workpiece W.

The workpiece recovering area 30 is located at the down stream side of the pickup area 28 in the flow direction of the workpiece. At the workpiece recovering area 30, the workpiece W, that is not picked up at the pickup area 28, is returned to the bowl 18. In detail, the workpiece W is returned from the conveyance carrier 8 to the bowl 18 via a workpiece recovering portion 32 located at the workpiece recovering area 30.

### Robot

The robot 4 is a horizontal articulated robot, a so-called SCARA robot, having a plurality of arm members 10A, 10B, 10C, each of which moves in the horizontal direction. In this embodiment, these arm members 10A, 10B, 10C constitute the arm mechanism 10. However, the robot 4 is not limited to a horizontal articulated robot, but may be a vertical articulated robot or an orthogonal robot (gantry robot). The robot 4 is turned between the conveyance carrier 8 and the place position of the next process.

As shown in FIG. 2, the robot 4 of this embodiment has: a base 36 fixed to the floor surface; and three arm members 10A, 10B, 10C, the first arm member to the third arm member. However, the number of arm members is not limited to three. In the following description, in the robot 4, the side that is fixed is referred to as a “base end side”, and the side that picks up the workpiece W is referred to as a “tip end side”. In other words, the robot 4 is fixed at the base end and picks up the workpiece W on the conveyance carrier 8 at the tip end.

The first arm member 10A extending in the horizontal direction is in a square bar shape or a flat plate shape, a base end 10Aa of which is connected to the upper surface of the base 36 so as to be turned freely around a first rotational axis AX1 in the vertical direction. The second arm member 10B extending in the horizontal direction is in a square bar shape or a flat plate shape, a base end 10Ba of which is connected to a tip end 10Ab of the first arm member 10A so as to be turned freely around a second rotational axis AX2 in the vertical direction.

The third arm member 10C extending in the vertical direction is a cylindrical shaft member and inserted into a tip end 10Bb of the second arm member 10B. The third arm member 10C is movable with respect to the tip end 10Bb of the second arm member 10B in the vertical direction and rotatable about a third rotational axis AX3 in the vertical direction. The hand 6 is attached to a lower end 10Ca of the third arm member 10C.

The hand 6 picks up the workpiece W on the conveyance carrier 8 and places the workpiece W on the place position in the next process. In this embodiment, the hand 6 is attached to the lower end 10Ca of the third arm member 10C so as to be turned freely around the third rotational axis AX3 in the vertical direction. However, the attachment structure of the hand 6 is not limited to this. The hand 6 of this embodiment is a chuck device having a plurality of claws that can be opened and closed. However, the hand 6 is not limited to the chuck device, but mat be, for example, a suction pad.

In this way, the robot 4 of this embodiment includes: the first arm member 10A that is turned around the first rotational axis AX1; the second arm member 10B that is turned around the second rotational axis AX2; and the third arm member 10C that is turned around the third rotational axis AX3. The first rotational axis AX1 is a rotational axis at the most basal end side.

The arm members 10A, 10B, 10C of the arm mechanism 10 is driven by an actuator (not illustrated). For example, the actuator is an electric motor, but is not limited to this.

As shown in FIG. 1, in the robot 4, the first rotational axis AX1 at the most basal end side is located inside a virtual circle VC of the conveyance carrier 8. In this case, the “virtual circle VC” refers to an inner diameter circle of the conveyance carrier 8, i.e., a circle formed by an inner edge of the conveyance carrier 8. In this embodiment, a rotational axial body 20 shown in FIG. 2 rotates around the first rotational axis AX1.

In this embodiment, as shown in FIG. 1, the conveyance carrier 8 is formed in a circular shape, but may be in an elliptic shape. In this case, in the robot 4, the first rotational axis AX1 at the most basal end side is located inside a virtual ellipse VC of the conveyance carrier 8. In this case, the “virtual ellipse VC” refers to an inner diameter ellipse of the conveyance carrier 8, i.e., an ellipse formed by an inner edge of the conveyance carrier 8.

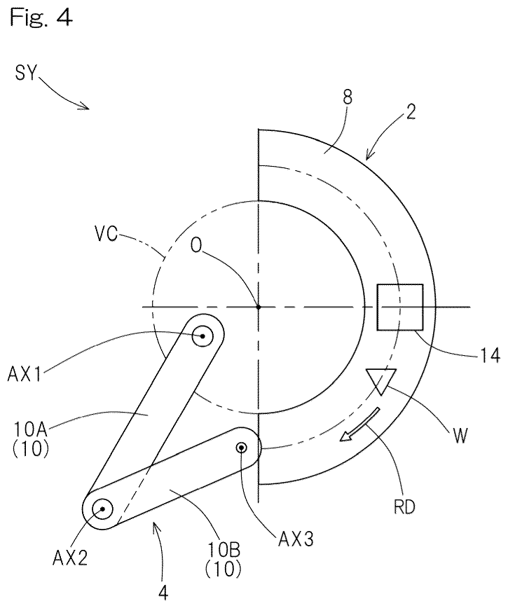

In addition, in this embodiment, the conveyance carrier 8 is formed in a circular shape, but may be in an arc shape as shown in a variation of FIG. 4. In the example of FIG. 4, the conveyance carrier 8 is in a semi-circular shape, i.e., an arc shape whose central angle is 180°. However, the central angle is not limited to 180°, but any angle can be set in accordance with an installation situation.

Even in the example of FIG. 4, in the robot 4, the first rotational axis AX1 at the most basal end side is also located inside a virtual circle VC of the conveyance carrier 8. In this case, the “virtual circle VC” refers to a circle formed by extending the inner edge of the conveyance carrier 8 that is in an arc shape. In other words, the “virtual circle VC” is an inner diameter circle when the central angle of an arc of the conveyance carrier 8 is 360°.

In the example of FIG. 4, the conveyance carrier 8 is formed in an arc shape, but may be in an elliptic shape. In this case, in the robot 4, the first rotational axis AX1 at the most basal end side is also located inside a virtual ellipse VC of the conveyance carrier 8. In this case, the “virtual ellipse VC” refers to an ellipse formed by extending the inner edge of the conveyance carrier 8 that is in an elliptic arc shape. In other words, the “virtual ellipse VC” is an inner diameter ellipse when the central angle of an elliptic arc of the conveyance carrier 8 is 360°.

In this way, in the parts feeding system of the present disclosure, the conveyance carrier 8 is in a circular shape, an arc shape, an elliptic shape, or an elliptic arc shape, and, in the robot 4, the first rotational axial center AX1 at the most basal end side is also located inside the virtual circle VC or the virtual ellipse VC of the conveyance carrier. In addition, in the parts feeding system of the present disclosure, there may be a plurality of the arm members or there may be one arm member. When there is one arm member, the rotational axis at the most basal end side is the rotational axis of one arm member.

In this embodiment, the robot 4 is fixed to the floor surface, but as long as the first rotational axis AX1 is located inside the virtual circle VC, the robot 4 may not be fixed to the floor surface. For example, a gate-type frame may be provided, and the robot 4 may be provided in a suspended state by the frame. In addition, the rotational axes other than the first rotational axis AX1, in this embodiment, the second rotational axis AX2 and the third rotational axis AX3 may be located inside or outside the virtual circle VC.

### Operation

The operation of the parts feeding system SY including the parts feeder 2 will be described. The workpiece W put into the bowl 18 shown in FIG. 1 is aligned and conveyed on the spiral conveying path 18a to the workpiece discharging section 18b located at the uppermost position of the bowl 18 by vibration. The workpiece W aligned is fed from the workpiece discharging section 18b to the workpiece feeding area 24.

The workpiece detector 14 detects the position and posture of the workpiece W fed to the workpiece feeding area 24 in the sensing area 26 located at the down stream side of the workpiece feeding area 24. Specifically, the controller 12 determines whether or not the workpiece W can be picked up based on a signal from the workpiece detector 14. Further, when the workpiece W can be picked up, the controller 12 determines where the hand 6 should be set.

In the pickup area 28 located at the down stream side of the sensing area 26, the position of the hand 6 is set by moving the arm mechanism 10 of the robot 4 from the determination result based on the signal from the workpiece detector 14, and the hand 6 picks up the workpiece W at the set position. After the workpiece W is picked up, the arm mechanism 10 of the robot 4 is turned to the place position, and the hand 6 releases the workpiece W.

The workpiece W that is not picked up at the pickup area 28 is returned to the bowl 18 from the workpiece recovering area 30 located at the down stream side of the pickup area 28. The workpiece W returned to the bowl 18 is conveyed again on the conveying path 18a by vibration. Thereafter, this operation is repeated.

### Effects and Advantages

According to the above configuration, since the robot 4 is located inside the conveyance carrier 8 having a circular shape, an occupied area of the parts feeding system SY can be reduced. As a result, it is possible to achieve saving space of the whole system.

In addition, the parts feeder 2 includes the disk-shaped conveyance carrier 8 and the workpieces W is fed from its inside. Therefore, the space for the parts feeder 2 and the conveyance carrier 8 can be smaller than a liner conveyance carrier. As a result, it is possible to achieve further saving space of the whole system.

### Second Embodiment

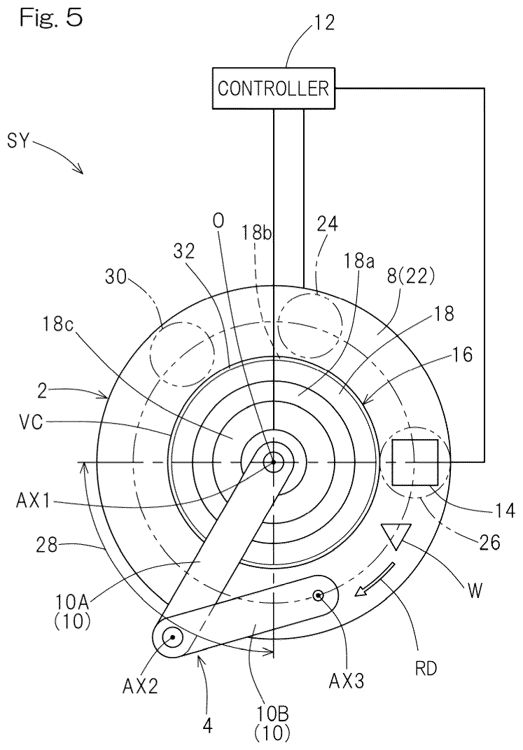

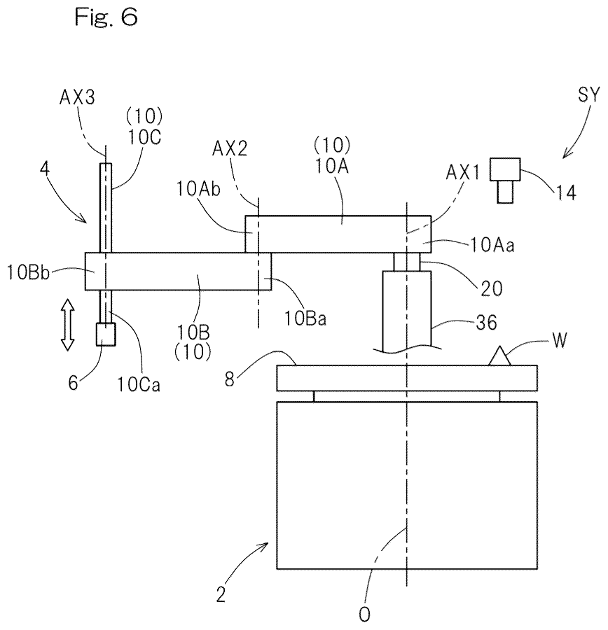

With reference to FIG. 5 to FIG. 7, a parts feeding system SY according to a second embodiment of the present invention will be described. FIG. 5 is a top plan view of the parts feeding system SY according to the second embodiment of the present invention, and FIG. 6 is a side view thereof. In the following description, the common reference numerals are used for the same features as in the first embodiment, and the detailed description is omitted.

As shown in FIG. 5, in the second embodiment, the robot 4 is located so that the first rotational axis AX1 of the robot 4 at the most basal end side corresponds to the center O of the virtual circle VC of the conveyance carrier 8. In detail, in the second embodiment, the center O of the virtual circle VC shown in FIG. 5 corresponds to the rotational center O of the rotating disk 22 of the conveyance carrier 8. In other words, the first rotational axis AX1 of the robot 4 at the most basal end side corresponds to the rotational center O of the rotating disk 22 of the conveyance carrier 8, and the first arm member 10A of the robot 4 and the rotating disk 22 (the conveyance carrier 8) rotate coaxially.

However, it is not necessary that the first rotational axis AX1 at the most basal end side corresponds to the center O of the virtual circle VC of the conveyance carrier 8. Specifically, it is sufficient that the robot 4 is located so that the first rotational axis AX1 at the most basal end side is located at the center portion of the conveyance carrier 8. In this case, “the first rotational axial center AX1 at the most basal end side is located at the center portion of the conveyance carrier 8” means that the rotational axis AX1 is located so that the robot 4 can follow the rotation of the conveyance carrier 8 as described below.

In the example of FIG. 5, the conveyance carrier 8 is formed in a circular shape, but may be in an elliptic shape. In this case, the robot 4 is located so that the first rotational axis AX1 of the robot 4 at the most basal end side corresponds to the center O of the virtual ellipse VC of the conveyance carrier 8. In this case, the “virtual ellipse VC” refers to an inner diameter ellipse of the conveyance carrier 8, i.e., an ellipse formed by an inner edge of the conveyance carrier 8. Also, in this case, the first rotational axis AX1 at the most basal end side may not correspond to the center O of the virtual ellipse VC of the conveyance carrier 8, but, for example, may be located at the center portion of the conveyance carrier 8.

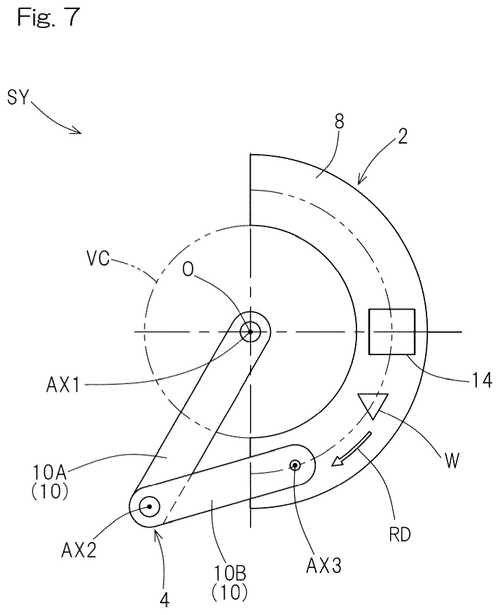

In addition, in the example of FIG. 5, the conveyance carrier 8 is formed in a circular shape, but may be in an arc shape as shown in a variation of FIG. 7. In the example of FIG. 7, the conveyance carrier 8 is in a semi-circular shape, i.e., an arc shape whose central angle is 180°. However, the central angle is not limited to 180°, but any angle can be set in accordance with an installation situation.

Even in the example of FIG. 7, the robot 4 is also located so that the first rotational axis AX1 of the robot 4 at the most basal end side corresponds to the center O of the virtual circle VC of the conveyance carrier 8. In this case, the “virtual circle VC” refers to a circle formed by extending the inner edge of the conveyance carrier 8 that is in an arc shape. In other words, the “virtual circle VC” is an inner diameter circle when the central angle of an arc of the conveyance carrier 8 is 360°. Also, in this case, the first rotational axis AX1 at the most basal end side may not correspond to the center O of the virtual circle VC of the conveyance carrier 8, but, for example, may be located at the center portion of the conveyance carrier 8

In the example of FIG. 7, the conveyance carrier 8 is formed in an arc shape, but may be in an elliptic arc shape. In this case, the robot 4 is also located so that the first rotational axis AX1 of the robot 4 at the most basal end side corresponds to the center O of the virtual ellipse VC of the conveyance carrier 8. In this case, the “virtual ellipse VC” refers to an ellipse formed by extending the inner edge of the conveyance carrier 8 that is in an elliptic arc shape. In other words, the “virtual ellipse VC” is an inner diameter ellipse when the central angle of an elliptic arc of the conveyance carrier 8 is 360°. Also, in this case, the first rotational axis AX1 at the most basal end side may not correspond to the center O of the virtual ellipse VC of the conveyance carrier 8, but, for example, may be located at the center portion of the conveyance carrier 8

In this embodiment, the robot 4 is fixed to the floor surface, but as long as the first rotational axial center AX1 is located inside the virtual circle VC, the robot 4 may not be fixed to the floor surface. For example, a gate-type frame may be provided, and the robot 4 may be provided in a suspended state by the frame. In addition, the rotational axes other than the first rotational axis AX1, in this embodiment, the second rotational axis AX2 and the third rotational axis AX3 may be located inside or outside the virtual circle VC.

### Operation

The operation of the parts feeding system SY including the parts feeder 2 will be described. The operation up to the point where the hand 6 picks up the workpiece W is the same as that of the first embodiment.

In the second embodiment, the first rotational axis AX1 of the robot 4 at the most basal end side corresponds to the rotational center O of the rotating disk 22 of the conveyance carrier 8, and the first arm member 10A of the robot 4 and the rotating disk 22 (the conveyance carrier 8) rotate coaxially. Accordingly, it is possible to enable the robot 4 to follow the rotation of the conveyance carrier 8, i.e., the movement of the workpiece W. In other words, making the robot 4 and the rotating disk 22 of the conveyance carrier 8 rotate synchronously around the first rotational axial center AX1 allows the first arm member 10A to the third arm member 10C of the robot 4 to follow the movement of the workpiece W. As a result, since complex coordinate calculations such as circular interpolation are not required, it is possible to simplify programming of the controller 12 and to shorten a control period.

After the workpiece W is picked up, the arm mechanism 10 of the robot 4 is turned to the place position, and the hand 6 releases the workpiece W. The workpiece W that is not picked up at the pickup area 28 is returned to the bowl 18 from the workpiece recovering area 30 located at the down stream side of the pickup area 28. The workpiece W returned to the bowl 18 is conveyed again on the conveying path 18a by vibration. Thereafter, this operation is repeated.

### Effects and Advantages

According to the second embodiment, the robot 4 is located so that the first rotational axis AX1 at the most basal end side corresponds to the center O of the virtual circle VD of the conveyance carrier 8. This makes it possible to reduce an occupied area of the parts feeding system SY. As a result, it is possible to achieve saving space of the whole system.

Moreover, according to the second embodiment, since the first rotational axis AX1 of the robot 4 at the most basal end side corresponds to the rotational center O of the rotating disk 22, the robot 4 can follow the rotation of conveyance carrier 8, i.e., the movement of the workpiece W. As a result, the robot 4 can be easily controlled.

### Third Embodiment

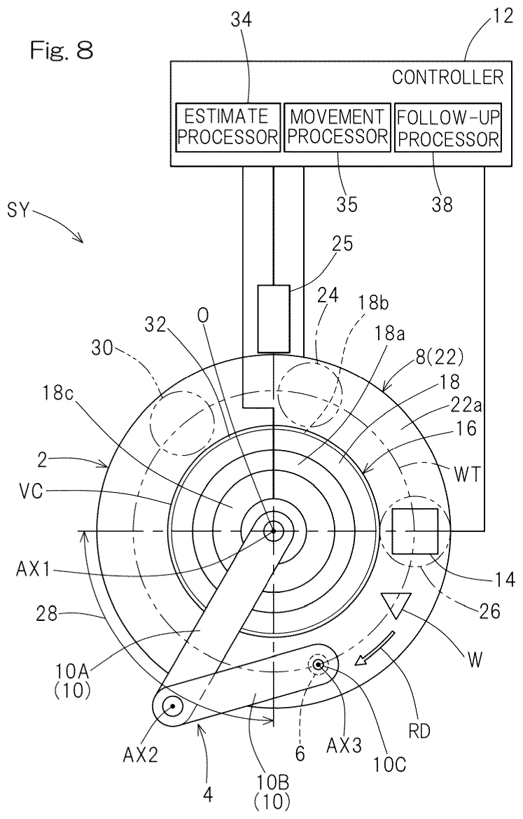

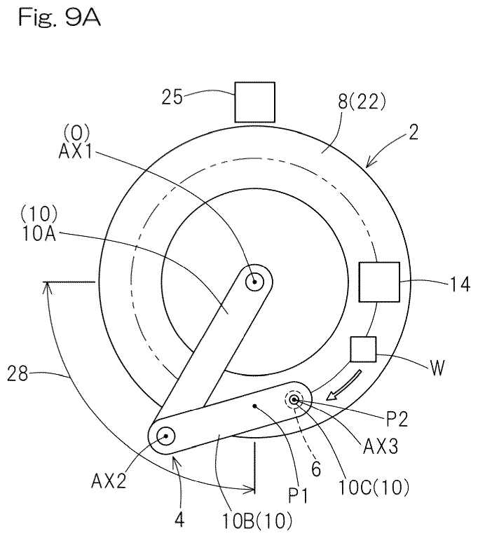

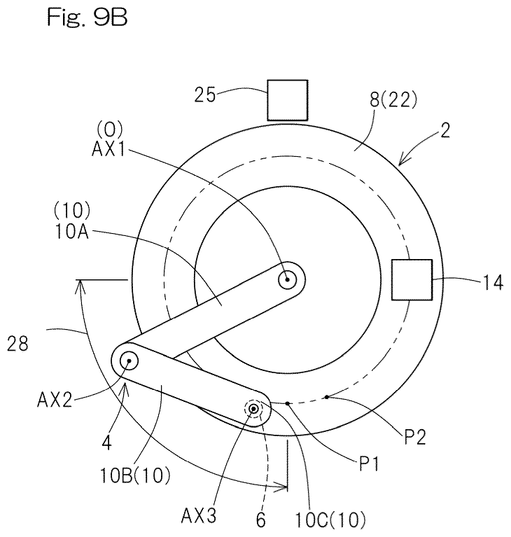

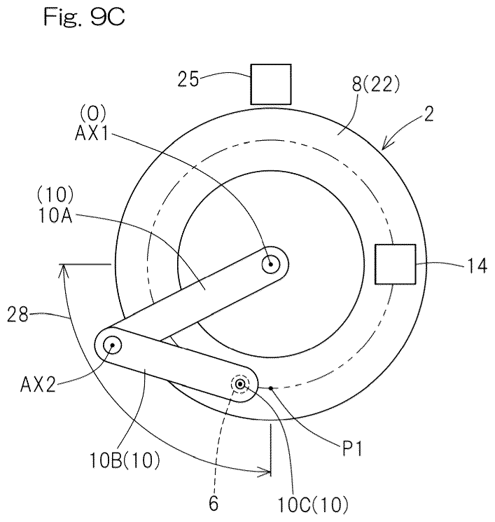

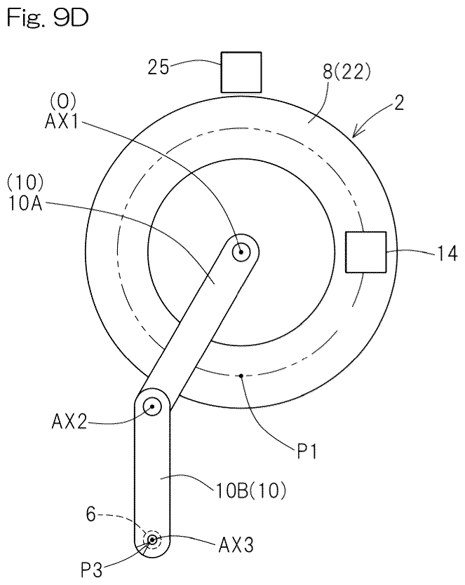

With reference to FIG. 8 to FIG. 9D, a third embodiment of the present invention will be described. The basic configurations of the parts feeder 2 and the robot 4 of the parts feeding system SY according to the third embodiment shown in FIG. 8 is the same as that of the second embodiment shown in FIG. 5 and FIG. 6. The common reference numerals are used for the same features as in the second embodiment, and the detailed description is omitted.

The parts feeding system SY of the third embodiment shown in FIG. 8 includes a rotation sensor 25 that detects the phase position of the rotating disk 22. The rotation sensor 25 detects, for example, a rotational angle of the rotating disk 22. The rotation sensor 25 of this embodiment is an encoder connected to a drive shaft of an electric motor. However, the rotation sensor 25 is not limited to this. The detected values by the rotation sensor 25 is transmitted to the controller 12.

As in the second embodiment above, in the third embodiment, the robot 4 is located so that the first rotational axis AX1 of the robot 4 at the most basal end side corresponds to the center O of the virtual circle VC of the conveyance carrier 8, i.e., the rotational center O of the rotating disk 22 of the conveyance carrier 8. In other words, the first rotational axis AX1 of the robot 4 at the most basal end side corresponds to the rotational center O of the rotating disk 22 of the conveyance carrier 8, and the first arm member 10A of the robot 4 and the rotating disk 22 (the conveyance carrier 8) rotate coaxially.

However, the first rotational axis AX1 at the most basal end side can be slightly shifted from the center O of the virtual circle VC of the conveyance carrier 8. In this case, “slightly shifted” means that the first rotational axis AX1 is shifted to the extent that the robot 4 can follow the movement of the workpiece W by rotating around the first rotational axis AX1. In this way, in this specification, “the first rotational axis AX1 at the most basal end side is slightly shifted from the center O of the virtual circle VC of the conveyance carrier 8” is defined as “the rotational axis AX1 at the most basal end side is located at the center of the conveyance carrier 8”.

### Controller

The controller 12 of the third embodiment controls the robot 4 based on the detected values by the workpiece detector 14 and the rotation sensor 25. The controller 12 of this embodiment performs image processing of the camera (the workpiece detector) 14 and controls the actuator (not illustrated) of the robot 4. In other words, in this embodiment, a single controller 12 integrally controls a robot and image processing.

The controller 12 of this embodiment performs image processing of the camera (the workpiece detector) 14 and controls the actuator (not illustrated) of the robot 4 by a central processing unit (CPU) executing a program installed therein. However, the controller 12 is not limited to this.

The controller 12 includes an estimate processor 34, a movement processor 35 and a follow-up processor 38. The estimate processor 34 calculates the timing when the workpiece W reaches a picking process starting position P1 and a standby position P2 on the upstream side of the picking process starting position P1 based on the detected values by the workpiece detector 14 and the rotation sensor 25.

In this case, the “picking process starting position P1” refers to the most upstream position of the pickup area 28. Specifically, it refers to the position on a workpiece track WT on the most upstream position of the pickup area 28. The “workpiece track WT” refers to a track drawn by the workpiece W moving on the conveyance surface 22a of the conveyance carrier 8.

The “standby position P2” is a position where the arm mechanism 10 of the robot 4, more specifically, the workpiece gripping portion (hand) 6 of the arm mechanism stands by before the hand 6 picking up the workpiece. In this embodiment, when the workpiece detector 14 confirms the workpiece W, the workpiece gripping portion 6 of the arm mechanism 10 moves to the standby position P2, but the workpiece gripping portion 6 may move before the workpiece detector 14 confirms the workpiece W. Further, in this embodiment, the standby position P2 is set on the workpiece track WT, but may not be set on the workpiece track WT. In addition, the standby position P2 may be set in the pickup area 28.

The movement processor 35 moves the workpiece gripping portion 6 of the arm mechanism 10 of the robot 4 to the standby position P2 before or simultaneously with the timing when the workpiece W reaches the standby position P2 calculated by the estimate processor 34.

The follow-up processor 38 makes the workpiece gripping portion 6 follow the movement of the workpiece W to pick up the workpiece W on the downstream side of the picking process starting position P1 by rotating the robot 4 around the first rotational axis AX1 at the timing when the workpiece W reaches the position just below the workpiece gripping portion 6 of the standby position P2.

### Operation

The operation of the parts feeding system SY including the parts feeder 2 will be described. The workpiece W put into the bowl 18 shown in FIG. 8 is aligned and conveyed on the spiral conveying path 18a to the workpiece discharging section 18b located at the uppermost position of the bowl 18 by vibration. The workpiece W aligned is fed from the workpiece discharging section 18b to the workpiece feeding area 24.

The workpiece detector 14 detects the position and posture of the workpiece W fed to the workpiece feeding area 24 in the sensing area 26 located at the down stream side of the workpiece feeding area 24. Specifically, the estimate processor 34 of the controller 12 calculates the timing when the workpiece W reaches the picking process starting position P1 and the standby position P2 based on the position of the workpiece W detected by the workpiece detector 14 and the phase position of the rotating disk 22 detected by the rotation sensor 25.

After the timing is calculated, as shown in FIG. 9A, the movement processor 35 moves the workpiece gripping portion 6 of the arm mechanism 10 of the robot 4 to the standby position P2 before the timing when the workpiece W reaches the standby position P2 (standby state). Alternatively, the movement processor 35 may move the workpiece gripping portion 6 of the arm mechanism 10 of the robot 4 to the standby position P2 simultaneously with the timing when the workpiece W reaches the standby position P2.

As shown in FIG. 9B, the follow-up processor 38 (FIG. 1) of the controller 12 makes the workpiece gripping portion 6 follow the movement of the workpiece W by rotating the robot 4 around the first rotational axis AX1 at the timing when the workpiece W reaches the position just below the workpiece gripping portion 6 of the standby position P2 (follow-up state). Specifically, the robot 4 rotates around the first rotational axis AX1 at the same rotational speed as the rotating disk 22.

At this time, the first rotational axis AX1 of the robot 4 at the most basal end side corresponds to the rotational center O of the rotating disk 22 of the conveyance carrier 8, and the first arm member 10A of the robot 4 and the rotating disk 22 (the conveyance carrier 8) rotate coaxially. Accordingly, it is possible to enable the robot 4 to follow the rotation of the conveyance carrier 8, i.e., the movement of the workpiece W. In other words, making the robot 4 and the rotating disk 22 of the conveyance carrier 8 rotate synchronously around the first rotational axis AX1 allows the first arm member 10A to the third arm member 10C of the robot 4 to follow the movement of the workpiece W.

Following the workpiece W, the workpiece gripping portion 6 of the robot 4 picks up the workpiece W on the pickup area 28 on the downstream side of the picking process starting position P1 shown in FIG. 9C (pickup state). Specifically, after the third arm mechanism 10C moves downward and the workpiece gripping portion 6 picks (grips) up the workpiece W, the third arm mechanism 10C moves upward.

After the workpiece W is picked up, the arm mechanism 10 of the robot 4 shown in FIG. 9D is turned to a place position P3, and the workpiece gripping portion 6 releases the workpiece W (place state). Specifically, the first arm mechanism 10A rotates around the first rotational axis AX1, the second arm mechanism 10B rotates around the second rotational axis AX2, and the third arm mechanism 10C moves downward and the workpiece gripping portion 6 places the workpiece W.

The workpiece W that is not picked up at the pickup area 28 shown in FIG. 8 is returned to the bowl 18 from the workpiece recovering area 30 located at the down stream side of the pickup area 28. The workpiece W returned to the bowl 18 is conveyed again on the conveying path 18a by vibration. Thereafter, this operation is repeated.

In this embodiment, the workpiece gripping portion 6 of the robot 4 is set to move to the specific standby position P2 (for example, a standby state of FIG. 9A), but the arm mechanism 10 of the robot 4 may not move to the specific standby position P2. For example, when the workpiece W is continuously fed, the workpiece gripping portion 6 of the robot 4 may stand by at the place position P3 of FIG. 9D.

In this case, the estimate processor 34 may calculate only the timing when the workpiece W reaches the picking process starting position P1 based on the detected values by the workpiece detector 14 and the rotation sensor 25. Before or simultaneously with this timing, the movement processor 35 may move the workpiece gripping portion 6 of the robot 4 to the position just above the picking process starting position P1. Further, the follow-up processor 38 may make the workpiece gripping portion 6 follow the movement of the workpiece W to pick up the workpiece W by rotating the robot 4 around the first rotational axis AX1 at the timing when the workpiece W reaches the picking process starting position P1.

### Effects and Advantages

According to the above configuration, as shown FIG. 8, the first rotational axis AX1 of the robot 4 at the most basal end side corresponds to the rotational axial center O of the conveyance carrier 8 having the rotating disk shape. This allows the workpiece gripping portion 6 of the robot 4 and the conveyance carrier 8 to rotate synchronously without complex coordinate calculations such as circular interpolation. Accordingly, it is possible to enable the robot 4 to follow the workpiece W moving on the rotating disk 22 at the downstream side beyond the first rotational axial center AX1.

In this way, since complex coordinate calculations are not required, it is possible to simplify programming of the controller 12 and to shorten a control period (tact time). In addition, since the following is performed only by rotation around the first rotational axis AX1, there is no interference between the arms 10 moving, which improves positioning accuracy.

Moreover, the robot 4 is located so that the first rotational axis AX1 at the most basal end side corresponds to the center O of the virtual circle VC of the conveyance carrier 8. This makes it possible to reduce an occupied area of the parts feeding system SY. As a result, it is possible to achieve saving space of the whole system.

In addition, the parts feeder 2 includes the disk-shaped conveyance carrier 8 and the workpieces W is fed from its inside. Therefore, the space for the parts feeder 2 and the conveyance carrier 8 can be smaller than a liner conveyance carrier. As a result, it is possible to achieve further saving space of the whole system.

The present disclosure is not limited to the foregoing embodiments, and various additions, changes, or omissions can be made therein without departing from the principle of the present disclosure. Accordingly, such variants are also encompassed within the scope of the present disclosure.

### REFERENCE NUMERALS

2 . . . parts feeder
4 . . . robot
6 . . . hand
8 . . . conveyance carrier
10A, 10B, 10C . . . arm member
12 . . . controller
14 . . . workpiece detector
16 . . . vibrating bowl feeder
18 . . . bowl
18a . . . conveying path
22 . . . rotating disk
22a . . . conveyance surface
25 . . . rotation sensor
34 . . . estimate processor
35 . . . movement processor
38 . . . follow-up processor
AX1 . . . first rotational axis (rotational axis at the most basal end side)
AX1, AX2, AX3 . . . rotational axis
O . . . center
P1 . . . picking process starting position
P2 . . . standby position
SY . . . parts feeding system
VC . . . virtual circle or virtual ellipse of the conveyance carrier
W . . . workpiece
WT . . . workpiece track

What is claimed is:

1. A parts feeding system comprising:
a conveyance carrier having an arc shape including a circular shape or an elliptic arc shape including an elliptic shape for conveying a workpiece;
a parts feeder feeding the workpiece to the conveyance carrier; and
a robot fixed at a base end thereof and picking up the workpiece on the conveyance carrier at a tip end thereof, wherein
the robot has an arm member rotating around a rotational axis, and
the rotational axis at the most basal end side is located inside a virtual circle or a virtual ellipse of the conveyance carrier.

2. The parts feeding system as claimed in claim 1, wherein the robot is located so that the rotational axis at the most basal end side is located at a center portion of the conveyance carrier.

3. The parts feeding system as claimed in claim 2, wherein the robot is located so that the rotational axis at the most basal end side corresponds to the center of the virtual circle or virtual ellipse of the conveyance carrier.

4. The parts feeding system as claimed in claim 1, wherein the robot has a plurality of the arm members.

5. The parts feeding system as claimed in claim 1, wherein the conveyance carrier is in a circular shape, or in an elliptic shape.

6. The parts feeding system as claimed in claim 5, wherein
the parts feeder includes: a vibrating bowl feeder having a bowl that conveys and feeds the stored workpiece along a conveying path while aligning the stored workpiece by vibration; and a conveyance carrier that conveys the aligned workpieces fed from the vibrating bowl feeder,
the conveyance carrier is arranged in an annular shape along an outer periphery of the vibrating bowl feeder, and
the conveyance carrier has a rotating disk having an upper surface which forms a conveyance surface of the workpiece.

7. A parts feeding system comprising:
a conveyance carrier having a rotating disk shape for conveying a workpiece;
a robot fixed at a base end thereof and picking up the workpiece moving on the conveyance carrier at a tip end thereof;
a workpiece detector that detects the position of the workpiece on the conveyance carrier;
a rotation sensor that detects a phase position of the rotating disk; and
a controller that controls the robot based on the detected values by the workpiece detector and the rotation sensor, wherein
the robot has an arm member rotating around a rotational axis,
the robot is located so that the rotational axis at the most basal end side is located at a center portion of the conveyance carrier, and
the robot rotates around the rotational axis at the most basal end side.

8. The parts feeding system as claimed in claim 7, wherein the robot is located so that the rotational axis at the most basal end side corresponds to a rotational axial center of the conveyance carrier.

9. The parts feeding system as claimed in claim 8, wherein the robot has a plurality of the arm members.

10. The parts feeding system as claimed in claim 9, wherein the controller includes:
an estimate processor that calculates a timing when the workpiece reaches a picking process starting position based on the detected values by the workpiece detector and the rotation sensor;
a movement processor that moves a workpiece gripping portion of the arm located at the tip end of the robot to a position just above the picking process starting position before or simultaneously with the timing when the workpiece reaches the picking process starting position calculated by the estimate processor; and
a follow-up processor that makes the workpiece gripping portion follow the movement of the workpiece to pick up the workpiece by rotating the robot around the rotational axis at the most basal end side at the timing when the workpiece reaches the picking process starting position.

11. The parts feeding system as claimed in claim 9, wherein the controller includes:
an estimate processor that calculates a timing when the workpiece reaches the picking process starting position and a standby position on a workpiece track on the upstream side of the picking process starting position based on the detected values by the workpiece detector and the rotation sensor;
a movement processor that moves a workpiece gripping portion of the arm located at the tip end of the robot to the standby position before or simultaneously with the timing when the workpiece reaches the standby position calculated by the estimate processor; and
a follow-up processor that makes the workpiece gripping portion follow the movement of the workpiece to pick up the workpiece on the downstream side of the picking process starting position by rotating the robot around the rotational axis at the most basal end side at the timing when the workpiece reaches the position just below the workpiece gripping portion.

12. The parts feeding system as claimed in claim 7, further comprising a parts feeder feeding the workpiece to the conveyance carrier, wherein
the parts feeder includes: a vibrating bowl feeder having a bowl that conveys and feeds the stored workpiece along a conveying path while aligning the stored workpiece by vibration; and a conveyance carrier that conveys the aligned workpieces fed from the vibrating bowl feeder,
the conveyance carrier is arranged in an annular shape along an outer periphery of the vibrating bowl feeder, and
the conveyance carrier has a rotating disk having an upper surface which forms conveyance surface of the workpiece.
